(19) United States
(12) Patent Application Publication
(10) Pub. No.: US 2017/0122626 A1
(43) Pub. Date: May 4, 2017

(54) Regenerator

(71) Applicant: ThermoLift, Inc., Stony Brook, NY (US)

(72) Inventors: Paul Schwartz, Woodbury, NY (US); Seann Convey, Roslyn, NY (US); David Yates, Ann Arbor, MI (US); Gregory McFadden, Everett, WA (US)

(73) Assignee: ThermoLift, Inc., Stony Brook, NY (US)

(21) Appl. No.: 15/342,204

(22) Filed: Nov. 3, 2016

Related U.S. Application Data
(60) Provisional application No. 62/249,964, filed on Nov. 3, 2015.

(51) Int. Cl. F25B 9/14; F02G 1/057

(52) U.S. Cl. CPC F25B 9/14; F02G 1/057; F25B 2309/003; F02G 2257/00

(57) ABSTRACT

Regenerators for Stirling engines and Vuilleumier heat pumps are difficult to reliably manufacture. A regenerator is disclosed in which edges of the regenerator wire meshes are coated with a stabilizing material. The regenerator wire meshes are then sufficiently stable to be machined to the dimensions of the housing. In some embodiments, the material on the outer surface of the edges of the regenerator is relatively thermally insulating to limit heat transfer to the housing.

### FIELD

The present disclosure relates to a regenerator and a method to fabricate and package such regenerator.

### BACKGROUND

A regenerator is one of the most important components in a Stirling engine or Vuilleumier heat pump. It can be analogized as a thermal sponge or thermal capacitor which cyclically absorbs and desorbs large amounts of thermal energy. When the working fluid (commonly helium) flows from the heater end to the cool end, the hot gas flowing through the regenerator transfers energy to the metal screen matrix of the regenerator acting as a heat sink. When the working fluid is caused to flow in the other direction, energy stored in the regenerator is transferred to the gases as they pass through.

Regenerators are finicky at best. They tend to be produced of a matrix of thin wires that ultimately succumb to fatigue due to the flow cycling bending the wires as the flow reverses. The production failure rate is very high. The layers are squeezed and sintered. Then, they are packaged in a housing and must seal against the surfaces of the housing lest a low-resistance flow path allows too much of the flow to bypass the regenerator. Often in the manufacturing process, the regenerator matrix is damaged. In some applications, less than a 50% success rate is achieved, which leads to significant cost overruns. For complicated shapes that might be helpful to reduce dead volume in the Stirling engine or Vuilleumier heat pump, the success rate is even lower and costs are higher.

FIG. 1 shows a regenerator 100, such as that disclosed in published application US 2012/0151912, which has multiple metal meshes cut into an annular shape. Each mesh 102 is made up of vertical wires 104 and horizontal wires 106. Meshes are formed or cut into the desired shape to fit into the housing, an annulus in the example in FIG. 1. The meshes are each in a plane with the planes of the meshes mutually parallel. Gas flow 130 through the regenerator is perpendicular to the plane of mesh 102. When many meshes 102 are stacked, they form an outer surface 110 that is generally parallel to the direction of flow 130. And in the case of a regenerator that fits into an annular volume, an inner surface 112 is also formed which is also generally parallel to the direction of flow is formed. The surfaces are fragile and consist of the spikey ends of individual wires. Consistently packaging such a regenerator core into a housing while sealing the regenerator core within the housing presents many challenges.

### SUMMARY

To overcome at least one problem in the prior art, a regenerator is disclosed that has a plurality of wire mesh layers forming a three-dimensional volume. Each layer has a substantially similar cross-sectional shape and the plurality of wire mesh layers lying in mutually parallel planes. A material is applied to sides of the regenerator with the sides perpendicular to the mutually parallel planes of the wire mesh layers. The sides are machined to a desired shape and surface finish. The wire mesh layers include at least one of: a woven fabric of wires; a random, substantially planar layer of wires; and a planar, non-woven, regular pattern of wires.

In some embodiments, the material is added via one of: plasma spraying and thermal spraying. In other embodiments, the material applied to the sides is a liquid paste. The liquid paste is one of: a liquid metal that is liquid due to being at high temperature and a braze paste that includes metallic particles and a solvent with the solvent driven off via heating the regenerator. Alternatively, a powder is applied to the sides. The powder is one that when heated liquefies or partially liquefies and then forms a solid when cooled

In another alternative, the material is applied by an electrochemical plating process. It is desirable for the material to be a relative thermal insulator having a thermal conductivity less than about 30 W/m-K. In situations where the material is thermally conductive, an insulating sleeve may be employed.

In some embodiments, a coating is applied to the material on the sides of the regenerator. The coating has a thermal conductivity much lower than the thermal conductivity of the material on the sides of the regenerator.

Also disclosed is a regenerator formed of a plurality of wire mesh layers forming a three-dimensional volume. Each layer has a substantially similar cross-sectional shape and the plurality of wire mesh layers lie in mutually parallel planes. A liquefied material is applied to sides of the regenerator wherein the sides are perpendicular to the mutually parallel planes of the wire mesh layers; and the liquefied material become solid when cooled. Material applied to the sides are machined so that the regenerator has predetermined dimensions.

In many embodiments, the material applied to the sides has a thermal conductivity lower than the wire mesh material.

A process to fabricate a regenerator is also disclosed. The process includes: stacking a plurality of wire mesh layers, the wire mesh layers having at least one of layers of organized wires, layers of woven mesh, and layers of random wires; compressing the plurality of wire mesh layers; sintering the plurality of wire mesh layers; cutting the plurality of layers of wire mesh to a desired shape; and applying a solid material to sides of the regenerator. The regenerator has a plurality of layers of wire mesh. The layers of wire mesh lie in mutually parallel planes. The sides of the regenerator are perpendicular to the mutually parallel planes of the wire meshes.

In some embodiments, the applying a solid material includes: heating up a solder-like material to a liquid state, rolling the regenerator in the liquid solder-like material, and allowing the regenerator to cool.

Alternatively, applying a solid material means spraying on the material via one of a plasma process and a thermal process.

In other alternatives, applying a solid material includes placing a powder on the sides, heating the regenerator so that the powder material adheres to the sides, and allowing the regenerator to cool.

In some embodiments, applying a brazing material that includes metallic components and a solvent, heating the regenerator to drive off the solvent, and cooling the regenerator to harden remaining brazing material.

The process, in some embodiments, further includes: applying a thermally-insulating coating onto the solid material on the sides of the regenerator.

In embodiments such as an annulus, sides include at least an outer side and an inner side.

Optionally, a thermally-insulating sleeve is slipped over the regenerator and the regenerator is inserted into the housing.

The process may further include machining the sides to a predetermined shape to thereby allow the regenerator to be inserted into the housing.

In some embodiments, the wire mesh comes as a coil or a large sheet and is first cut into a rectangular shape prior to stacking the plurality of wire mesh layers.

A key advantage of providing material is the robustness of the regenerator: greater production success and extended lifetime in operation. Also, by costing edges of the meshes, the regenerator is sufficiently robust to allow machining of the surfaces to obtain the desired dimensions for fitting into a housing. A good fit is desired to avoid leak pathways for the flow to go around the regenerator.

Another advantage is realized when the material added to the surfaces is of low conductivity because the heat transfer lost to the housing is minimized.

### BRIEF DESCRIPTION OF THE DRAWINGS

FIG. 1 is an illustration of a prior art regenerator;

FIG. 2 is an illustration of a regenerator according to an embodiment of the disclosure;

FIG. 3 is an illustration of a regenerator to be inserted into a housing; and

FIG. 4 is a flowchart showing one embodiment of a process by which a regenerator is fabricated.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

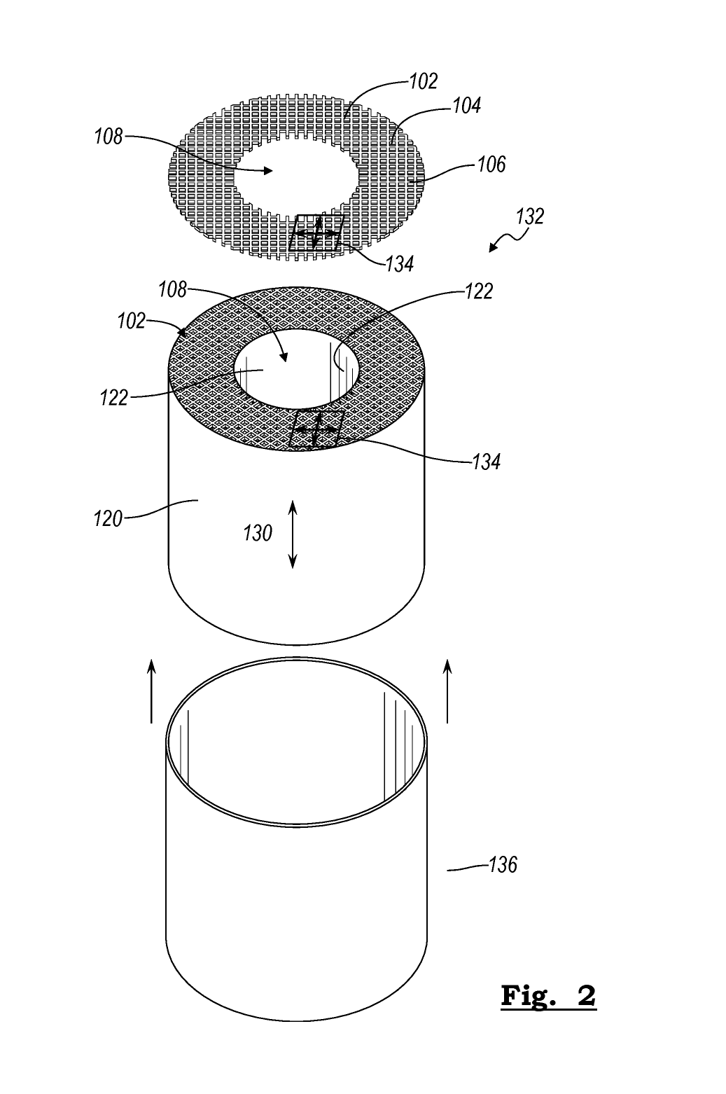

In FIG. 2, a regenerator 132 is shown which has vertical wires 104 and horizontal wires 106. Regenerator 132 is annular and has a cylindrical opening 108. Sides 120 and 122 of regenerator 132 that are parallel to the general direction of flow 130 of gases, are coated. That is, the spikey ends of meshes 102 are covered in material. The general direction of flow 130 is perpendicular to a plane 134 in which mesh 102 sits. In one embodiment, sides 120 and 122 are covered by thermal or plasma spraying. Such material stabilizes the ends of meshes 102 making it more robust for further processing. After spraying sides 120 and 122 of regenerator 132, sides 120 and 122 can be machined to the dimensions of the housing and to provide the desired surface finish. Regenerator 132 is a collection of annularly-shaped meshes forming a 3-dimensional shape that has an inner diameter and an outer diameter. Wire meshes 102 lie in mutually parallel planes 134, respectively. The shape of regenerator 132 in FIG. 2 is one non-limiting example. Alternatively, regenerator 132 could be sectioned into multiple arcs, a parallelepiped, a solid cylinder, or any suitable shape that fits into the space designed into the housing.

The layers of mesh visible in FIG. 2 have a rectilinear appearance, which could be due to the wires placed like that or woven. Other alternatives exist, including a random arrangement of wires and other regular or repeating patterns of wires with or without weaving, or any other suitable arrangement.

In an alternative embodiment, sides 120 and 122 of regenerator 132 are costed with a liquid solder or a braze paste. The braze paste has an organic solvent and metal. Regenerator 132 is heated thereby releasing the solvent and melting the metal. When cooled the metal solidifies to hold edges of mesh layers 102 into place. In yet another alternative, a powder coating is applied that when heated melts and fuses the tips of the cut mesh material.

A desired characteristic of a regenerator is that energy transfer within the regenerator is primarily in plane 134 and much less so in the direction of flow 130. Furthermore, energy transfer into the regenerator's housing is undesirable. Thus, a material with a low thermal conductivity on the outer surfaces of the sides is desirable. Such material may be titanium, stainless steel, or metallic oxides such as aluminum oxide or zirconium oxide. In some embodiments, a very thin metal layer is applied, a metal that has high strength to stabilize the meshes, then followed by a layer of a material of low thermal conductivity.

In one embodiment, a thin insulating sleeve 136 is slid over regenerator 132 as shown in FIG. 2. Alternatively, sleeve 136 is placed into the housing prior to regenerator 132 being slid into the housing. In such embodiment, sleeve 136 is slid into the housing prior to sliding regenerator 132 into the housing. Alternatively, the insulating material is sprayed into the housing prior to regenerator 132 being slid therein. If material on sides 120 and 122 that is used to secure the edges of the meshes is sufficiently insulating, such sleeve 136 may be obviated.

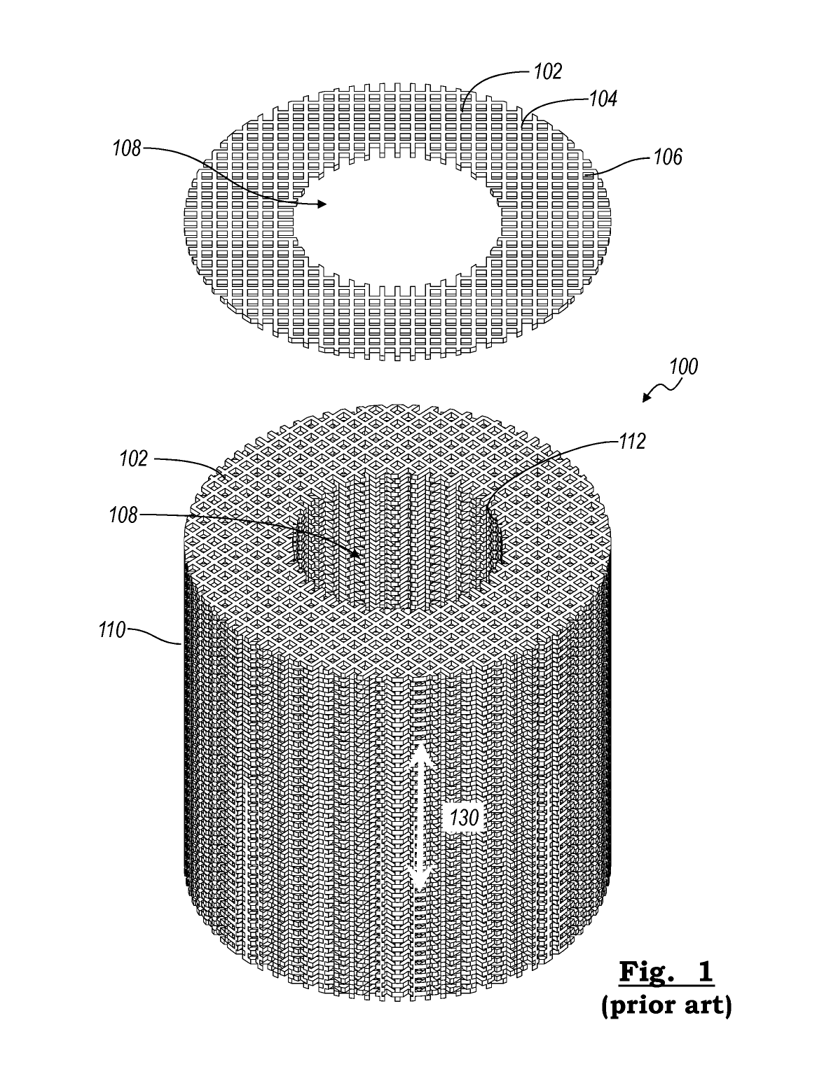

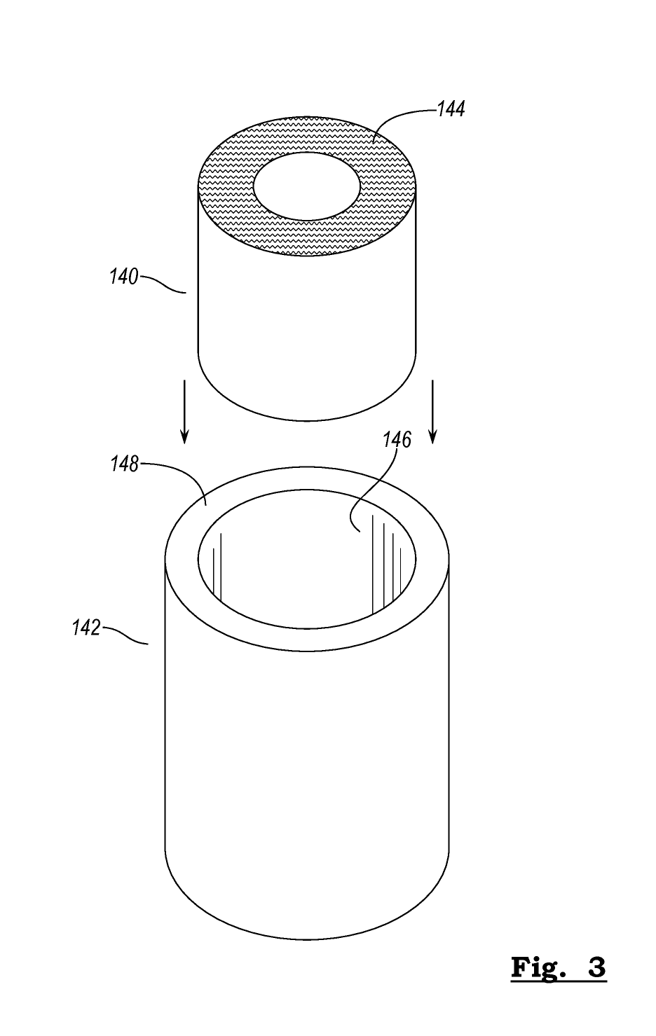

In FIG. 3, regenerator 140 fabricated of multiple meshes 144, of a different arrangement than meshes in FIGS. 1 and 2, is slid into an open annular region 148 in a housing 142 that has an interior cylinder 146 in which a displacer or piston may reciprocate.

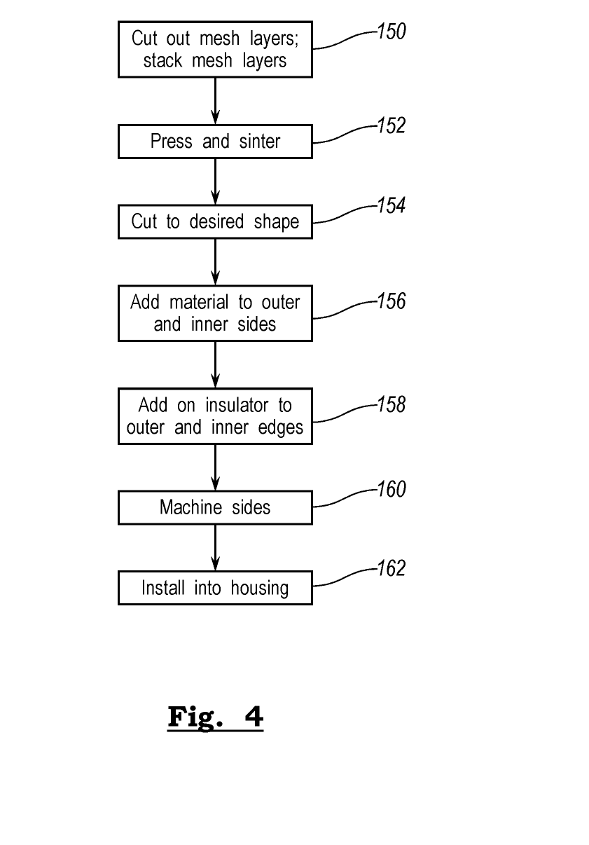

One embodiment of a process by which a regenerator is fabricated is shown in FIG. 4. The mesh layers are cut out to the desired shape and then stacked in block 150. In some embodiments, the mesh material come in a roll and rectangular pieces are cut out the bulk material. In embodiments where the material is fabricated into a desired starting geometry, the process in block 150 is eliminated. In block 152, the stack of mesh layers is pressed and then sintered. In block 154, the sintered stack of mesh layers is cut to a desired shape. In block 156, material is added to outer sides of the regenerator. Various options, e.g., plasma spraying, braze paste, are discussed in more detail above. The sides are the outer surfaces which are roughly parallel to the direction of flow, which is roughly perpendicular to the planes of the individual meshes. Depending on the geometry, there may also be inner sides, such as the inside of an annulus. In that case, the material is provided to the inners sides as well. Optionally, an insulating layer is added to outer surfaces of the regenerator in block 158. In other embodiments, an insulating layer is not provided because the material added in block 156 is sufficiently insulating. In block 6-8, the sides are machined so that they fit into the housing and have the desired surface finish. The regenerator is installed into the housing in block 162. As described above, if the system has a separate insulating sleeve, that can be applied to the regenerator prior to installation into the housing or installed into the housing before the housing receives the regenerator.

As described above, the material supplied to the sides is optionally: plasma sprayed, thermally sprayed, electroplated coated with a liquid solder, coated with a braze paste, or provided by any suitable method for adding material. In the case of the braze paste, the regenerator is heated to liberate the organic solvent. The list of materials that can be thermally sprayed is extensive. Furthermore, materials that can be applied via other processes contemplated herein is also extensive. A few examples are provided above; a comprehensive list is not included.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A regenerator, comprising:
a plurality of wire mesh layers forming a three-dimensional volume wherein each layer has a substantially similar cross-sectional shape and the plurality of wire mesh layers lying in mutually parallel planes; and
a material applied to sides of the regenerator, the sides being perpendicular to the mutually parallel planes of the wire mesh layers wherein:
the sides are machined to a desired shape and surface finish; and
the wire mesh layers comprise at least one of:
a woven fabric of wires;
a random, substantially planar layer of wires; and
a planar, non-woven, regular pattern of wires.

2. The regenerator of claim 1 wherein the material is added via one of: plasma spraying and thermal spraying.

3. The regenerator of claim 1 wherein:
the material applied to the sides is one of a liquid paste and a powder:
the liquid paste is one of: a liquid metal that is liquid due to being at high temperature and a braze paste that includes metallic particles and a solvent with the solvent driven off via heating the regenerator; and
the powder forms a solid when cooled after heating to a predetermined temperature.

4. The regenerator of claim 1 wherein the material is applied by an electrochemical plating process.

5. The regenerator of claim 1 wherein the material is a relative thermal insulator having a thermal conductivity less than about 30 W/m-K.

6. The regenerator of claim 1, further comprising:
a coating applied to the material on the sides of the regenerator, the coating having a thermal conductivity much lower than the thermal conductivity of the material on the sides of the regenerator.

7. A regenerator, comprising:
a plurality of wire mesh layers forming a three-dimensional volume wherein each layer has a substantially similar cross-sectional shape and the plurality of wire mesh layers lying in mutually parallel planes; and
a liquefied material applied to sides of the regenerator wherein the sides are perpendicular to the mutually parallel planes of the wire mesh layers; and the liquefied material become solid when cooled wherein the wire mesh layers comprise at least one of:
a woven fabric of wires;
a random, substantially planar layer of wires; and
a planar, non-woven, regular pattern of wires.

8. The regenerator of claim 7 wherein material applied to the sides are machined so that the regenerator has predetermined dimensions.

9. The regenerator of claim 7 wherein the material applied to the sides has a thermal conductivity lower than the wire mesh material.

10. A process for fabricating a regenerator, comprising:
applying a solid material to sides of the regenerator, the regenerator being comprised of a plurality of layers of wire mesh wherein the layers of wire mesh lie in mutually parallel planes; and the sides of the regenerator are perpendicular to the mutually parallel planes of the wire meshes.

11. The process of claim 10, further comprising:
stacking a plurality of wire mesh layers, the wire mesh layers having at least one of layers of organized wires, layers of woven mesh, and layers of random wires;
compressing the plurality of wire mesh layers;
sintering the plurality of wire mesh layers; and
cutting the plurality of layers of wire mesh to a desired shape.

12. The process of claim 10 wherein the applying a solid material comprises:
heating up a solder-like material to a liquid state;
rolling the regenerator in the liquid solder-like material; and
allowing the regenerator to cool.

13. The process of claim 10 wherein applying a solid material comprises spraying on the material via one of a plasma process and a thermal process.

14. The process of claim 10 wherein applying a solid material comprises:
placing a powder on the sides;
heating the regenerator so that the powder material adheres to the sides; and
allowing the regenerator to cool.

15. The process of claim 10 wherein applying a solid material comprises:
applying a brazing material that includes metallic components and a solvent;
heating the regenerator to drive off the solvent; and
cooling the regenerator to harden remaining brazing material.

16. The process of claim 10, further comprising:
applying a thermally-insulating coating onto the solid material on the sides of the regenerator.

17. The process of claim 10 wherein the sides comprise at least an outer side and an inner side.

18. The process of claim 10, further comprising:
installing a thermally-insulating sleeve over the regenerator; and
inserting the regenerator into the housing.

19. The process of claim 10, further comprising: machining the sides to a predetermined shape to thereby allow the regenerator to be inserted into the housing.

20. The process of claim 11, further comprising:
cutting the plurality of wire mesh layers to a rectangular shape prior to stacking the plurality of wire mesh layers.
